(19) United States
(12) Patent Application Publication
(10) Pub. No.: US 2012/0192615 A1
(43) Pub. Date: Aug. 2, 2012

(54) Mechanical Press Adapted for Hot-Forming Processes

(75) Inventors: Iñaki Martinez Ortiz del Rio, Victoria-Gasteiz (Araba) (ES); Mikel Bikandi Bikandi, Durango (Bizkaia) (ES)

(73) Assignee: FAGOR, S. COOP., Arrasate-Mondragon (ES)

(21) Appl. No.: 13/364,206

(22) Filed: Feb. 1, 2012

(30) Foreign Application Priority Data
Feb. 2, 2011 (ES) P201130131

(51) Int. Cl. B21J 9/10; B21D 37/18; B21J 13/00; B30B 1/26

(52) U.S. Cl. 72/446; 100/282; 72/352; 72/429

(57) ABSTRACT

Mechanical presses adapted for forming processes. In one implementation the mechanical press includes two dies adapted for forming a piece, a motor, a crankshaft attached to the motor, a crank-connecting rod mechanism that attaches one of the dies to the crankshaft, and at least one lubricating bearing fixed to the crank-connecting rod mechanism. In one implementation the lubricating bearing comprises on an inner surface, a first area adapted for lubricating the crankshaft in a hydrostatic and a second area arranged substantially opposite to the first area adapted for lubricating the lubricating bearing in a hydrodynamic mode.

### CROSS-REFERENCE TO RELATED APPLICATIONS

This application relates to and claims the benefit and priority to Spanish Patent Application No. P201130131, filed Feb. 2, 2011.

### TECHNICAL FIELD

The invention relates to mechanical presses adapted to forming processes, such as stamping and forging, in which the dies of the mechanical press must be kept closed for a period of time, in particular hot-stamping processes in which the formed piece is cooled inside the closed, dies.

### BACKGROUND

There are known mechanical presses that comprise a lower die arranged on a bed, an upper part that includes an upper die capable of moving along guides, in relation to the bed, a motor that operates the press, and a crankshaft, the motor being arranged attached to the crankshaft by means of transmission means. The mechanical press also comprises a crank-connecting rod mechanism that attaches the crankshaft to the upper die, transmitting the movement of the crankshaft to the upper die, the upper die being moved along the guides.

In general terms, the mechanical presses adapted for forming processes such as stamping and forging, operate continuously without stopping in the lower dead center, the bearings operating in a hydrodynamic mode. In this type of machine the use of hydrodynamic bearings is known, as disclosed in U.S. Pat. No. 7,021,913 B3.

### SUMMARY OF THE DISCLOSURE

It is an object of this invention to provide a mechanical press adapted for forming processes, particularly hot forming.

According to one implementation a mechanical press is provided that comprises dies adapted for forming a piece, a motor, a crankshaft attached to the motor by transmission means, and a crank-connecting rod mechanism adapted for attaching one of the dies to the crankshaft.

The mechanical press comprises a lubricating bearing attached, to the crank-connecting rod mechanism inside which is housed the crankshaft

In one implementation the lubricating bearing comprises on an inner surface a first area adapted for lubricating the crankshaft in a hydrostatic mode which supports the load in start and stop conditions of the mechanical press, and a second area, arranged substantially opposite to the first area, adapted for lubricating the crankshaft in a hydrodynamic mode for the rest of the time for which the mechanical press is operating.

The two different lubrication areas in the lubricating bearing comprised in the mechanical press enable the use of mechanical presses in hot-forming processes for which the piece to be formed is cooled inside the dies. As a result, the mechanical press may operate by stopping at the dead center for a certain period of time, until the piece cools, and starting up again, the lubricating bearing supporting the load generated, and in addition, operating for the rest of the time for which the press is operating with hydrodynamic lubrication, which enables optimum lubrication at a lower cost than hydrostatic lubrication.

These and other advantages and characteristics of the invention will be made evident in the light of the drawings and the detailed description thereof.

### DESCRIPTION OF THE DRAWINGS

FIG. 1 shows a sectional view of a mechanical press according to one implementation.

FIG. 2 shows a partially sectional perspective of the coupling of a crankshaft to a crank-connecting rod mechanism in the mechanical press shown in FIG. 1.

FIG. 3 shows a longitudinal section of the lubricating bearing shown in FIG. 1.

FIG. 4 shows a cross-section of the lubricating bearing shown in FIG. 3 according to a line IV-IV.

FIG. 5 shows a sectional view in perspective of the lubricating bearing shown in FIG. 1.

FIG. 6 shows another sectional view in perspective of the lubricating bearing shown in FIG. 1.

### DETAILED DESCRIPTION

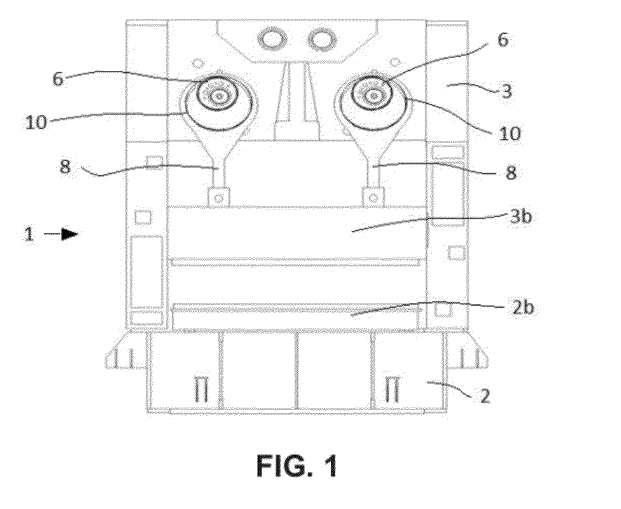

FIG. 1 shows a longitudinal section of a mechanical press 1 that comprises a bed 2 on which is supported a lower die 2b and an upper part 3 that includes an upper die 3b capable of moving along guides, not shown in the figures, in relation to the bed 2, the guides being arranged substantially orthogonal to the bed and to the upper part 3. The mechanical press 1 comprises a motor, not shown in the figures, housed in the upper part 3, a crankshaft 6, and transmission means, not shown in the figures, which attach the crankshaft 6 to the motor. In addition, the mechanical press 1 comprises a crank-connecting rod mechanism 8 that attaches the crankshaft 6 to the upper die 3b, transmitting the movement of the crankshaft 6 to the upper die 3b to cause the upper die 3b to be moved along the guides.

When operating, the mechanical press 1 converts the rotary movement of the crankshaft 6 into a movement of the upper die 3b, the force generated by the mechanical press 1 varying along its path according to the angle of application of the force, the greatest force being generated in the lower dead center of the mechanical press 1, in which both dies 2b,3b are in contact.

The mechanical press 1 is adapted for working in forming processes such as hot-stamping and forging, in which the piece to be formed is cooled between the upper die 3b and the lower die 2b. In other words, the mechanical press 1 remains in the lower dead center for a certain period of time. As a result, the crankshaft 6 must withstand high stresses when it is operated in order to separate the upper die 3b from the lower die 2b, the lubrication between the crankshaft 6 and the crank-connecting rod mechanism 8 being critical.

For this purpose, the mechanical press 1 comprises a lubricating bearing 10 fixed to the crank-connecting rod mechanism 8 and a tank where the lubricant is pumped by means of a hydraulic pump towards the lubricating bearing 10, neither the tank nor the hydraulic pump being shown in the figures.

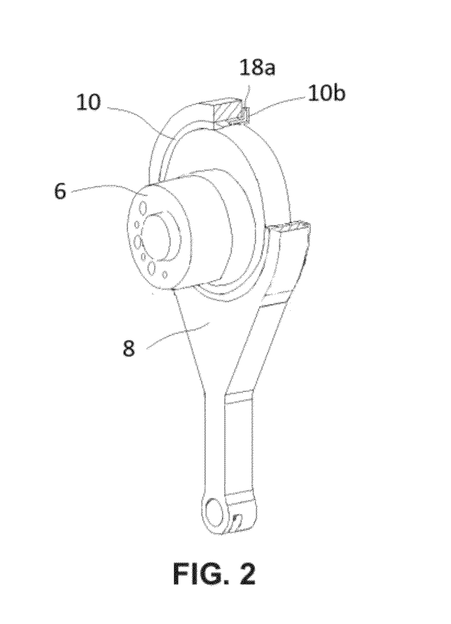

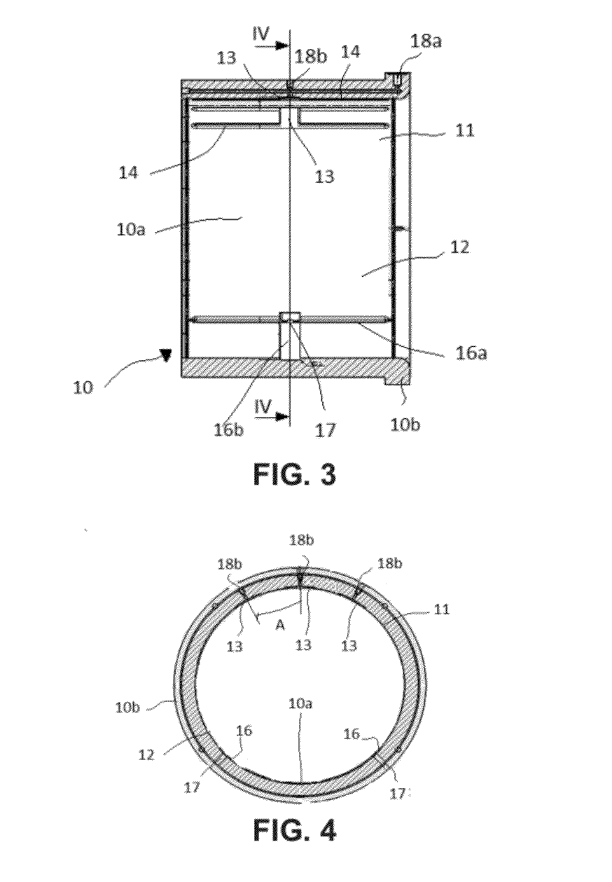

In one implementation the lubricating bearing 10, shown in detail in FIGS. 2 to 6, includes an end, an outer rim 10b, with the result that when the lubricating bearing 10 is fitted tightly in the crank-connecting rod mechanism 8, the rim 10b is arranged outside the crank-connecting rod mechanism 8, coming up against the crank-connecting rod mechanism 8.

Furthermore, the lubricating bearing 10 comprises on an inner surface 10a a first area 11 adapted for lubricating mainly in a hydrostatic mode for the start and stop actions of the mechanical press 1 and a second area 12, arranged. substantially diametrically opposite to the first area 11, adapted for lubricating in a hydrodynamic mode for the rest of the time, both areas 11,12 being continuous. In one implementation the first area 11 corresponds with a sector with a maximum angle of approximately 90°.

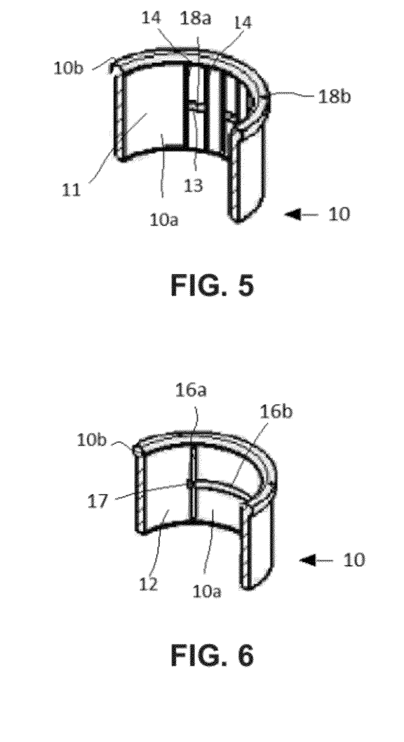

The first area 11, shown in detail in FIG. 5, comprises the surface that supports the greatest load and includes main channels 13 arranged substantially centered in relation to the length of the lubricating bearing 10, the main channel 13 being configured to support the load in conditions of little or no relative movement between the crankshaft 6 and the crank-connecting rod mechanism 8, in particular for start conditions of the mechanical press 1 after a time period in which a piece has cooled inside the die 4. In one implementation each main channel 13 has a substantially rectangular geometry being supplied independently with the pressurized lubricant fluid supplied by the hydraulic pump respectively through at least one nozzle 18a,18b, shown in FIGS. 2 to 5, which passes at least partially radially through the lubricating bearing 10.

In one implementation the main channels 13 are arranged substantially angularly equidistant from each other along part of the inner surface 10a of lubricating bearing 10 corresponding to the first area 11, the angle A of separation between two main channels 13 arranged adjacent to each other, shown in FIG. 4, being preferably approximately 30°. Each main channel 13 enables hydrostatic lubrication to take place, generating such a load capacity that when the lubricant fluid is introduced under pressure through the respective nozzle 18a,18b it enables it to keep the crankshaft 6 separated from the lubricating bearing 10 in order to support the load, for example, during the starting of the mechanical press 1, after the piece to be formed has cooled.

In one implementation the first area 11 also comprises elongated secondary channels 14 that extend longitudinally, substantially along the length of the lubricating bearing 10, being arranged substantially parallel to each other and connected to the respective main channel 13, the secondary channels 14 and the main channel 13 forming a substantially H-shaped geometry. As a result, preferably each main channel 13 has a secondary channel 14 arranged on each side, both secondary channels 14 being directly connected to the corresponding main channel 13. As a result, each secondary channel 14 is adapted for cooperating with the lubrication of the crankshaft 6 for operating in a hydrodynamic mode, allowing the first area 11 to remain lubricated both in a hydrostatic mode and in a hydrodynamic mode.

In one implementation the lubricating bearing 10 comprises a first nozzle 18a, that extends radially in the rim 10b from the outside, connecting to at least one of the secondary channels 14, and a second nozzle 18b that extends radially, centred in relation to the main channel 13, connecting to the main channel 13. In other implementations not shown in the figures, the lubricating bearing 10 may be arranged without the second nozzle 18b provided that through the first nozzle 18a the pressure of the lubricant fluid is maintained regardless of the direction of the rotation of the crankshaft 6.

In one implementation the second area 12, shown in detail in FIG. 6, comprises elongated first channels 16a that extend substantially longitudinally along the lubricating bearing 10. In one implementation the configuration of each first channel 16a being respectively similar to the surface of each secondary channel 14 comprised in the first area 11. The first channels comprised in the second area 12 are arranged connected to each other by means of a second channel 16b that extends perimetrally along part of the inner surface 10a of the lubricating bearing 10, being adapted for cooperating with the lubrication of crankshaft 6 for operating in a hydrodynamic mode, in conjunction with the secondary channels 14 comprised in the first area 11, allowing the inside of the lubricating bearing 10 to remain lubricated.

In the implementation shown in the figures, the lubricating bearing 10 comprises in at least one first channel 16a a first nozzle, not shown in the figures, that extends radially in the rim 10b, from the outside, connecting to the corresponding first channel 16a, and a second nozzle 17 that extends radially centred in relation to the second channel 16b, connecting to the first channel 16a and to the second channel 16b. In other implementations not shown in the figures, the lubricating bearing 10 may be arranged without the second nozzle 17 provided that through the first nozzle the pressure of the lubricant fluid is maintained regardless of the direction of rotation of the crankshaft 6.

Finally, these types of lubricating bearing may be used in any joint of the crank-connecting rod mechanism that houses in its interior a shaft, mainly the crankshaft.

1. A mechanical press comprising:
a fixed first die and a moveable second die, the lower and upper dies adapted for forming a piece when the second die is moved into contact with the first die;
a rotatable crankshaft operably connected to a motor;
a crank-connecting rod mechanism having a first end and a second end, the first end of the crank-connecting rod mechanism coupled to the crankshaft by a lubricating bearing fixed within a housing of the crank-connecting rod mechanism, the second end of the crank-connecting rod mechanism coupled to the second die, when rotated by the motor the crankshaft rotates within the lubricating bearing to induce a reciprocal movement of the crank-connecting rod mechanism that causes the second die to be moved toward and into contact with the first die and subsequently moved away and out of contact with the first die, the lubricating bearing comprising on an inner surface a first area and a second area arranged substantially opposite to the first area, the first area adapted for hydrostatic lubrication of the lubricating bearing when the crankshaft is stationary and the first and second dies are in contact with one another, the second area adapted for hydrodynamic lubrication of the lubricating bearing when the crankshaft is rotating.

2. A mechanical press according to claim 1, wherein the first area of the lubricating bearing comprises a main channel that receives a lubricant through one or more nozzles, the surface area of the main channel sized to support the load imposed on the lubricating bearing when the first and second dies are in contact with one another.

3. A mechanical press according to claim 2, wherein the main channel is, arranged substantially centered on the inner surface of the lubricating bearing.

4. A mechanical press according to claim 3, further comprising one or more secondary channels connected to the main channel, the one or more secondary channels arranged adjacent to the main channel and adapted for hydrodynamically lubricating the first area when the crankshaft is rotating.

5. A mechanical press according to claim 4, wherein the main channel has a substantially rectangular cross-section and the one or more secondary channels extend substantially along the length of the lubricating bearing and forming with the main channel a substantially H-shaped geometry.

6. A mechanical press according to claim 1, wherein the first area of the lubricating bearing comprises a plurality of main channels that each independently receive a lubricant through one or more nozzles, the combined surface area of the plurality of main channels sized to support the load imposed on the lubricating bearing when the first and second dies are in contact with one another.

7. A mechanical press according to claim 4, wherein the lubricating bearing comprises a first nozzle that extends from a rim of the lubricating bearing to at least one of the secondary channels.

8. A mechanical press according to claim 7, wherein the lubricating bearing comprises a second nozzle that extends radially through the lubricating bearing into a center region of the main channel.

9. A mechanical press according to claim 6, wherein the plurality of main channels are arranged substantially angularly equally spaced from each other along the first area.

10. A mechanical press according to claim 9, wherein the angle of separation between each of the plurality of main channels arranged is approximately 30°.

11. A mechanical press according to claim 2, wherein the first area corresponds with a sector with a maximum angle of 90°.

12. A mechanical press according to claim 6, wherein the first area corresponds with a sector with a maximum angle of 90°.

13. A mechanical press according to claim 2, wherein the second area of the lubricating bearing comprises a plurality of longitudinally first channels, the plurality of first channels being arranged connected to each other by a second channel that extends perimetrally between the plurality of first channels.

14. A mechanical press according to claim 13, wherein the lubricating bearing comprises in the second area a first nozzle that extends from a rim of the lubricating bearing to at least one of the first channels.

15. A mechanical press according to claim 14, wherein the lubricating bearing comprises a second nozzle that connects at least one of the first channels to the second channel.

16. A mechanical press according to claim 4, wherein the second area of the lubricating bearing comprises a plurality of longitudinally first channels, the plurality of first channels being arranged connected to each other by a second channel that extends perimetrally between the plurality of first channels.

17. A mechanical press according to claim 16, wherein the lubricating bearing comprises in the second area a first nozzle that extends from a rim of the lubricating bearing to at least one of the first channels.

18. A mechanical press according to claim 17, wherein the lubricating bearing comprises a second nozzle that connects at least one of the first channels to the second channel.

19. A mechanical press according to claim 5, wherein the second area of the lubricating bearing comprises a plurality of longitudinally first channels, the plurality of first channels being arranged connected to each other by a second channel that extends perimetrally between the plurality of first channels.

20. A mechanical press according to claim 19, wherein the lubricating bearing comprises in the second area a first nozzle that extends from a rim of the lubricating bearing to at least one of the first channels.

21. A mechanical press according to claim 20, wherein the lubricating bearing comprises a second nozzle that connects at least one of the first channels to the second channel.
